(19) United States
(12) Patent Application Publication
(10) Pub. No.: US 2005/0052559 A1
(43) Pub. Date: Mar. 10, 2005

(54) Image processing apparatus

(76) Inventor: Ikuo Hayaishi, Nagano-ken (JP)

Correspondence Address: MARTINE PENILLA & GENCARELLA, LLP, 710 LAKEWAY DRIVE, SUITE 200, SUNNYVALE, CA, 94085, US

(21) Appl. No.: 10/892,912

(22) Filed: Jul. 14, 2004

(30) Foreign Application Priority Data
Jul. 15, 2003 (JP) 2003-196888

(51) Int. Cl. H04N 5/225

(52) U.S. Cl. 348/335

(57) ABSTRACT

A technology for correcting deterioration in image quality due to the optical system without additional information other than that contained in an image data file is provided. The image data file GF includes image data GD generated by a digital camera and picture-taking condition information obtained during generation of the image data GD. The picture-taking condition information contains optical system setting information indicating the setting parameters of the optical system of the digital camera at the time of generation of the image data GD. The image processing apparatus that processes the image data GD in accordance with the contents of the image data file GF includes an image adjustment unit that adjusts the image quality of the image data GD based on this optical system setting information.

### BACKGROUND OF THE INVENTION

1. Field of the Invention

The present invention relates to an image processing technology used with image data generated by a digital camera.

2. Description of the Related Art

In an image input device such as a digital camera, an image is acquired by converting the optical image of the photographic subject that is formed by an optical system used by a photo imaging unit into electrical signals. As a result, the image quality of the acquired image may deteriorate due to aberration of the optical system depending on the condition of the optical system. To reduce this deterioration, image processing for an image quality improvement is carried out. For example, JP2002-207242A discloses an image processing method which improves image quality based on information relating to image quality deterioration caused by the optical system.

However, in the image processing method based on information relating to image quality deterioration, the information relating to image quality deterioration is stored separately from the image data file. In consequence, the task of managing the image data file and the image quality deterioration information becomes complex.

### SUMMARY OF THE INVENTION

An object of the present invention is to correct image quality deterioration due to the optical system without additional information other than that contained in the image data file.

According to an aspect of the present invention, there is provided an image processing apparatus that performs image processing of image data in accordance with contents of an image data file that includes the image data generated by a digital camera and information regarding picture-taking conditions in effect at the time of the image data generation. The apparatus comprises: an image quality adjuster configured to adjust image quality of the image data based on an optical system setting information included in the picture-taking condition information, the optical system setting information indicating setting parameters for an optical system of the digital camera at the time of the image data generation.

According to this image processing apparatus, image quality deterioration due to the optical system can be corrected without additional information other than that contained in the image data file.

The present invention may be realized in various embodiments, for example, an image processing method and image processing device; a computer program for realizing the functions of such a method or device; or a storage medium having such a computer program stored thereon.

Although the present invention has been described and illustrated in detail, it is clearly understood that the same is by way of illustration and example only and is not to be taken by way of limitation, the spirit and scope of the present invention being limited only by the terms of the appended claims.

### BRIEF DESCRIPTION OF THE DRAWINGS

FIG. 1 is a schematic diagram showing an image processing system 100 comprising an embodiment of the present invention.

FIG. 2 illustrates the arrangement of the digital still camera 200 as an image input device.

FIG. 3 is a light path diagram showing the situation in which the optical system 210 of the digital still camera 200 is focused at infinity.

FIG. 4 is a schematic block diagram showing the arrangement of the computer 120 and color printer 140 as an image data output apparatus.

FIG. 5 is an explanatory drawing of the structure of the image data file GF in the first embodiment.

FIG. 6 is an explanatory drawing of an example of the attribute information stored in the Exif IFD in the image data file GF.

FIGS. 7(a) and 7(b) show the MTF characteristics for different focal lengths of the optical system 210.

FIG. 8 is an explanatory drawing showing the contents of contrast adjustment in the first embodiment.

FIG. 9 is an explanatory drawing showing the determination of the contrast adjustment amount in the first embodiment.

FIGS. 10(a) and 10(b) show the MTF characteristics for the different aperture openings of the optical system 210.

FIG. 11 is an explanatory drawing showing the determination of the contrast adjustment amount in a second embodiment.

### DESCRIPTION OF THE PREFERRED EMBODIMENTS

Embodiments of the present invention will be described below in the following sequence.

A. First Embodiment:

B. Second Embodiment:

C. Modification:

A. First Embodiment:

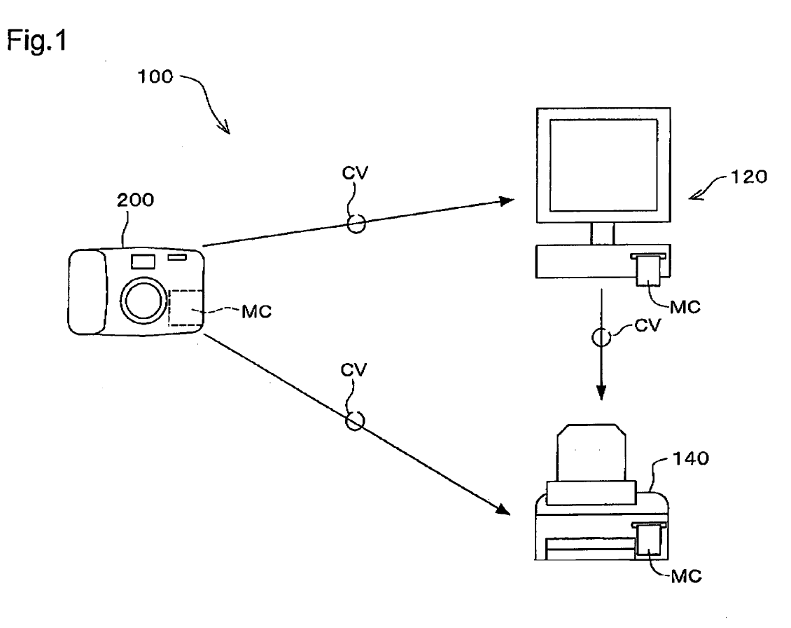

FIG. 1 is a schematic diagram showing an image processing system 100 comprising an embodiment of the present invention. This image processing system 100 includes a digital still camera 200, a personal computer 120 and a color printer 140. The digital still camera 200 generates image data that is processed by the image processing apparatus according to the present invention. The image processing apparatus incorporated in the personal computer 120 executes image quality adjustment on the image data generated by the digital still camera. The quality adjusted image data is output to the color printer 140 as an output device.

The digital still camera 200, the personal computer 120 and the color printer 130 can be connected each other by a cable CV. Where the cable CV is used to create such connections, the image data is sent and received between the digital still camera 200 and the personal computer 120 via the cable CV. Where the digital still camera 200 and the other apparatuses are not connected by a cable CV, the image data can be transferred by means of a memory card MC.

In the first embodiment, the image processing apparatus is incorporated in the personal computer 120, but the image processing apparatus may alternatively be incorporated in the color printer 140 or in the digital still camera 200.

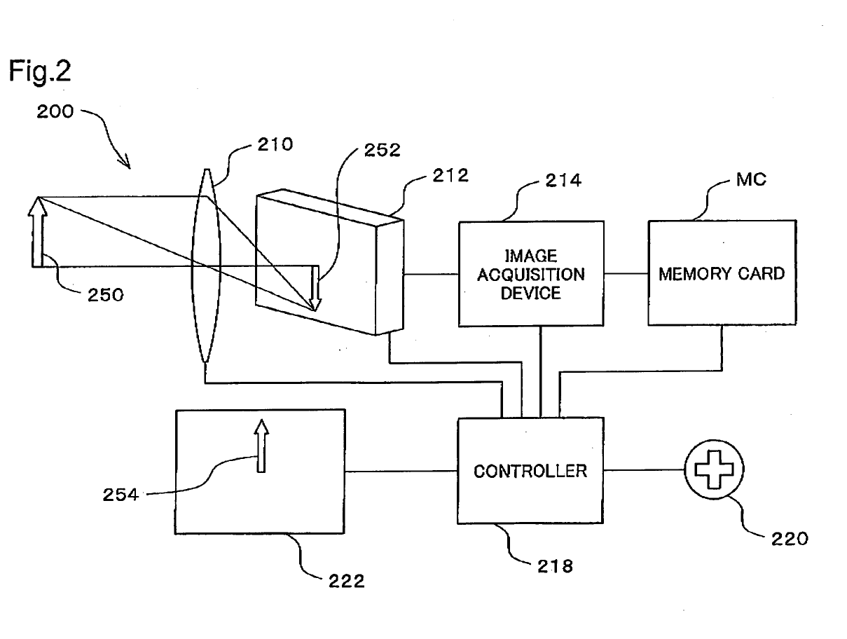

FIG. 2 illustrates the arrangement of the digital still camera 200 as an image input device. The photo imaging unit of the digital still camera 200 includes an optical system 210, a charge coupled device (CCD) 212 and an image acquisition device 214. An optical image 252 of an object 250 is formed on the acceptance surface of the CCD 212 by the optical system 210. While the optical system 210 has multiple lenses, an aperture, a zoom mechanism, only a single lens is shown in FIG. 2 for purposes of simplification.

The CCD 212 carries out photoelectric conversion to convert the brightness of the optical image 252 formed on the acceptance surface into electrical signals. The electrical signals output from the CCD 212 are converted into digital signals by an A/D converter incorporated in the image acquisition device 214, whereby image data is generated. When the shutter button is pressed, the image data is converted into a prescribed format by the image acquisition device 214 and recorded on the memory card MC as a image data file after addition of information on picture-taking condition and other information. The structure of the image data file is described below.

The digital still camera 200 includes a selection/confirmation button 220 as a user interface and a liquid crystal display 222 used for information display. A controller 218 controls the various components of the digital still camera 200 according to instructions by the user entered from the selection/confirmation button 220 and various items of information issued by the photo imaging unit. The liquid crystal display 222 is also used as a picture-taking preview device or a finder for the digital still camera 200. In this case, the controller 218 transfers the image data generated by the image acquisition device 214 to the liquid crystal display 222 on which an image 254 is displayed.

In the first embodiment, the CCD 212 is used as a device to perform photoelectric conversion, but any device that converts the brightness of the optical image 252 into electrical signals, such as a MOS image sensor, image pickup tube or other photoelectric conversion element, may be used as a photoelectric conversion device.

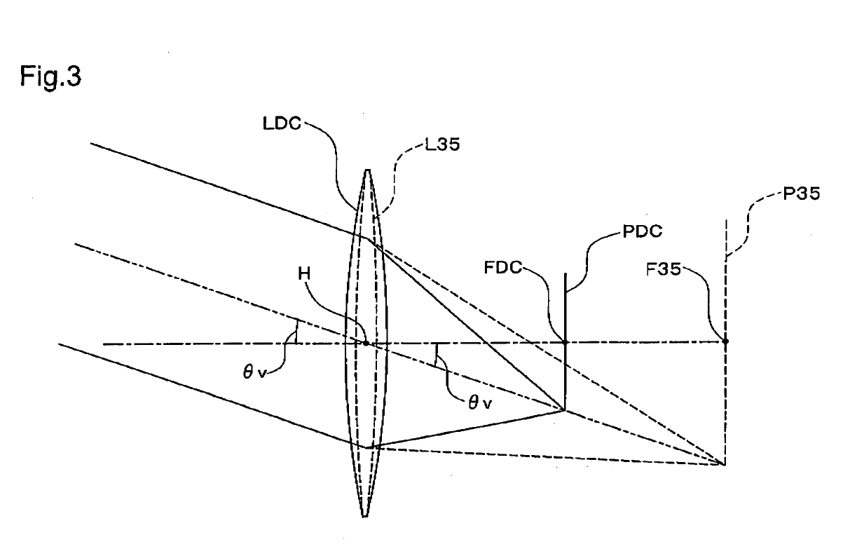

FIG. 3 is a light path diagram showing the situation in which the optical system 210 of the digital still camera 200 is focused at infinity. In FIG. 3, the optical system 210 of the digital still camera 200 is substituted by an equivalent thin lens LDC and the acceptance surface of the CCD 212 is shown as a picture plane PDC of a digital still camera having the same size.

The solid lines in FIG. 3 show the convergence of parallel rays that enter the lens LDC at an angle relative to the optical axis expressed as a chain line. The parallel incident rays are converged into a point located on a plane that is perpendicular to the optical axis and traverses the focal point FDC of the lens LDC (such plane is called the ‘focal plane’). Where the angle formed by the parallel incident rays and the optical axis is greater than the angle θv formed by the optical axis and the straight line that connects an end of the picture plane PDC and the principal point H of the lens LDC (such an angle is called the ‘field angle’), the light converged by the lens LDC does not enter the picture plane PDC. Therefore, the image capture range of the digital still camera 200 is the range in which the angle formed by the parallel rays and the optical axis does not exceed the field angle θv.

Since the CCD 212 used in the digital still camera 200 may have various sizes, the picture plane PDC may have various sizes as well. As described above, because the field angle θv is determined by the size of the picture plane PDC and the focal length of the lens LDC, the field angle θv may be different even if the focal length of the lens LDC remains the same. Accordingly, the focal length of the optical system 210 is expressed using a value termed the focal length in 35 mm film. The focal length in 35 mm film is the focal length at which the field angle where the picture plane is set to have the same size as the picture plane P35 of a 35 mm camera is identical to the field angle θv of the digital still camera 200. As can be appreciated from the description above, the focal length in 35 mm film is a value that effectively indicates the field angle.

The focal length in 35 mm film can be determined by the following method. First, the picture plane P35 of a 35 mm camera is positioned such that the edge thereof is disposed on a path of the principal ray of the parallel rays that enter the lens LDC at the angle relative to the optical axis (the chain double-dashed line in FIG. 3). It is assumed that a lens L35 of a 35 mm film camera has a principal point ‘H’, and the focal point thereof is the point of intersection F35 between the picture plane P35 and the optical axis of this system. Here, the field angle determined by the focal length of the lens L35 and the size of the picture plane P35 equals the field angle θv of the digital still camera 200. Thus the focal length in 35 mm film of the optical system 210 is determined as the focal length of the lens L35. In the first embodiment, the image contrast is adjusted using this focal length in 35 mm film, as described below.

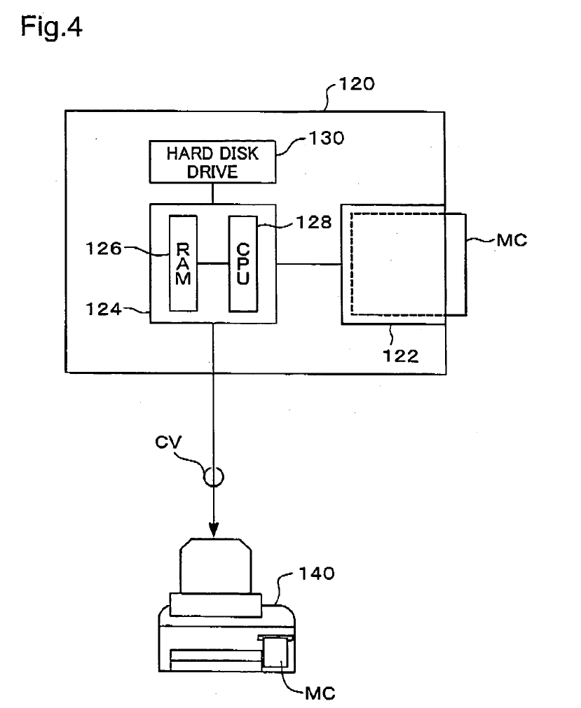

FIG. 4 is a schematic block diagram showing the arrangement of the computer 120 and color printer 140 as an image data output apparatus. The computer 120 includes a slot 122 that can read an image data file from the memory card MC and a print data generator 124 that generates print data to make the color printer 140 to perform printing.

The print data generator 124 includes a processor (CPU) 128 that performs arithmetic processing to generate print data, a hard disk drive 130 that stores computer programs executed by the CPU 128, the results of the arithmetic processing performed by the CPU 128 and other types of data, and a random access memory (RAM) 126 that temporarily stores these computer programs and data. The print data generator 124 also has a function to carry out image processing of the image data prior to the generation of print data.

The hard disk drive 130 of the computer 120 stores, as an image processing software, data for determining the image quality adjustment parameters based on the picture-taking condition information and a computer program that carries out image quality adjustment of the image data based on the determined parameters. In the first embodiment, the image processing device is incorporated in the print data generator, but any arrangement is acceptable so long as the image processing device can carry out prescribed image processing, and therefore it may be constructed as an independent unit, for example. The adjusted image data is converted into print data by the print data generator 124 and sent to the color printer 140.

The color printer 140 is an inkjet printer that can output color images. It discharges ink of multiple colors onto a printing medium in accordance with the print data sent from the print data generator 124. Dot patterns are formed by the discharged ink, thereby forming print images. The four ink colors of cyan (C), magenta (M), yellow (Y) and black (K) are used as the multiple ink colors.

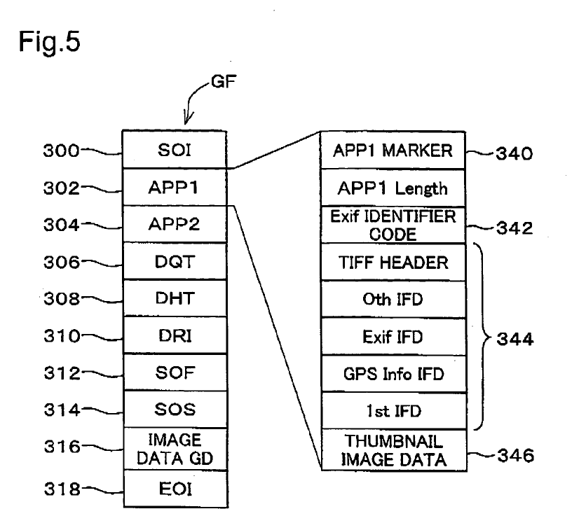

FIG. 5 is an explanatory drawing of the structure of the image data file GF in the first embodiment. The image data file GF has a file structure in accord with the Exif digital still camera image data file format standard. This standard was established by the Japan Electronics and Information Technology Industries Association (JEITA). According to this standard, an Exif file (Exif-standard file) incorporates a JPEG-Exif file in which compressed JPEG data is stored as image data.

The image data file GF includes an SOI marker segment 300 that indicates the start of the compressed data, an APP1 marker segment 302 that stores Exif attribute information, an APP2 marker segment 304 that stores Exif extension data, a DQT marker segment 306 that defines a quantization table, a DHT marker segment 308 that defines a Huffman table, a DRI marker segment 310 that defines an insertion interval for a restart marker, an SOF marker segment 312 that indicates various frame-related parameters, an SOS marker 314 that indicates various scan-related parameters, an EOI marker segment 318 that indicates the end of the compressed data, and a image data storage area 316.

The APP1 marker segment 302 stores an APP1 marker 340, an Exif identifier code 342, attribute information 344 including a TIFF header and other attribute information, and a thumbnail image data 346. The attribute information 344 has a TIFF data structure that includes a file header (TIFF header), and in Exif-JPEG, it includes a 0th IFD that stores compressed image data-related attribute information, an Exif IFD that stores Exif-specific attribute information, such as the picture-taking condition information PI, a GPS Info IFD that stores GPS measurement information, and a 1st IFD that stores thumbnail image-related attribute information. The Exif IFD is pointed to by the offset from the TIFF header stored in the 0th IFD. In an IFD, tags are used to specify various information, and each item of information may be called using a tag name.

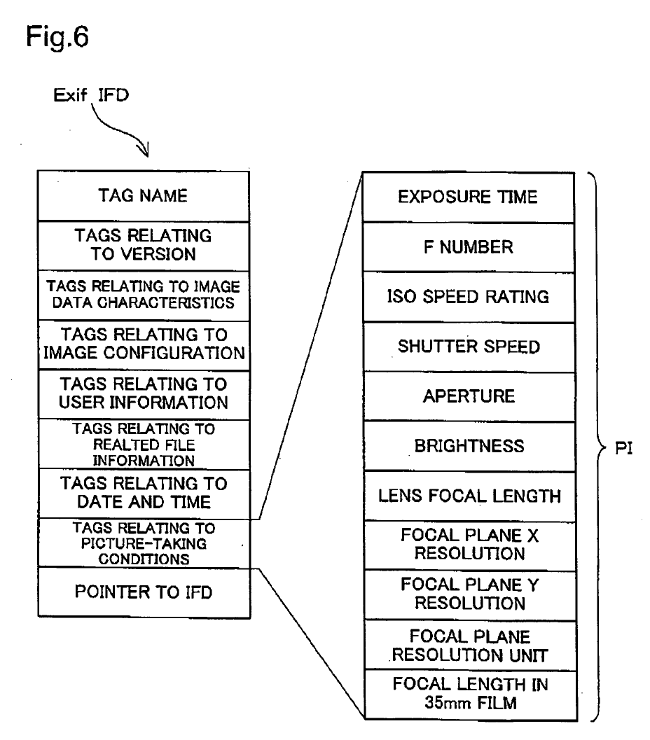

FIG. 6 is an explanatory drawing of an example of the attribute information stored in the Exif IFD in the image data file GF. The attribute information includes various tags, including tags relating to version and tags relating to picture-taking conditions. The F-number and the aperture, the lens focal length, the focal plane x resolution, the focal plane y resolution, the focal length in 35 mm film and other optical system setting information, as well as the exposure time, the ISO speed rating, the shutter speed, the brightness, the focal plane resolution unit and other parameter values, are stored as picture-taking condition information PI based on the default offset. The picture-taking condition information PI is recorded in the digital still camera 200 at the time of picture-taking as described above.

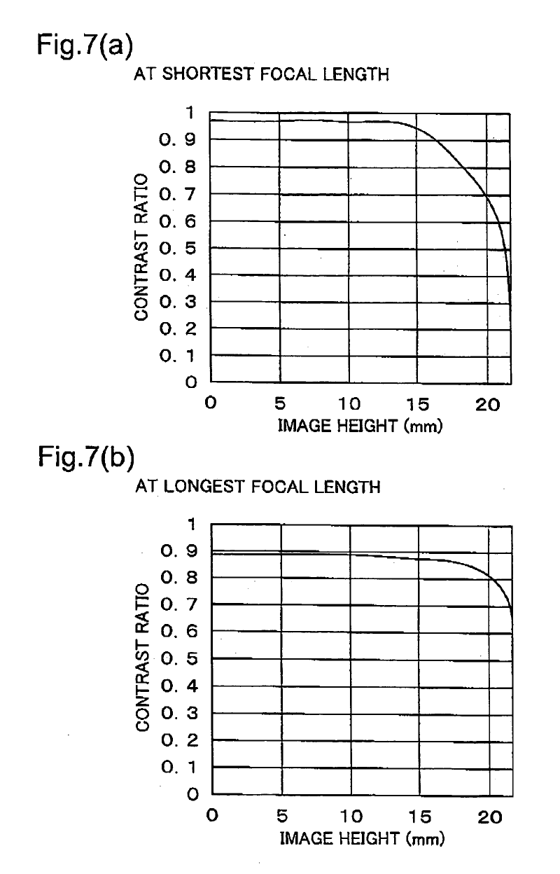

FIGS. 7(a) and 7(b) show the contrast ratio as a function of the image height (hereinafter the ‘MTF characteristics’) for different focal lengths of the optical system 210 (see FIG. 2). The image height in FIGS. 7(a) and 7(b) indicate the distance from the center of the optical system 210 (i.e., the optical axis) at the focal plane. The contrast ratio indicates the ratio between a contrast in an actual pattern and a contrast in its optical image when the optical system 210 forms a striped optical image having a prescribed spatial frequency from a striped pattern as a photographic subject.

FIG. 7(a) shows an example of the MTF characteristic where the focal length of the optical system 210 is shortest. FIG. 7(b) shows an example of the MTF characteristic where the focal length of the optical system 210 is longest. As shown in the figures, the image contrast decreases as the image height increases. Furthermore, in the region in which the image height is small, the contrast ratio decreases as focal length increases. The graphs in FIGS. 7(a) and 7(b) show the MTF characteristics where the aperture of the optical system 210 is in a fully open state (full aperture state), i.e., where the aperture is not narrowed.

Incidentally, in the ideal state in which the optical system has no aberration, each point of the photographic subject corresponds to each point on the image, and the brightness of each point on the image would be proportional to the brightness of each point on the photographic subject. Consequently, the image contrast in an ideal optical system would be equivalent to the contrast of a striped pattern, and the contrast ratio would be 1.

However, because aberration exists in an actual optical system, the image of each point of a photographic subject expands or blurs. As a result of this expansion, the optical images of the bright area of the striped pattern become mixed with the optical images of the dark area, and the image contrast becomes lower than that of the actual striped pattern. The decreased contrast caused by the aberration of the optical system can be corrected by using image processing. Specifically, the contrast of the original photographic subject can be reproduced by performing adjustment to increase the contrast of the decreased-contrast image.

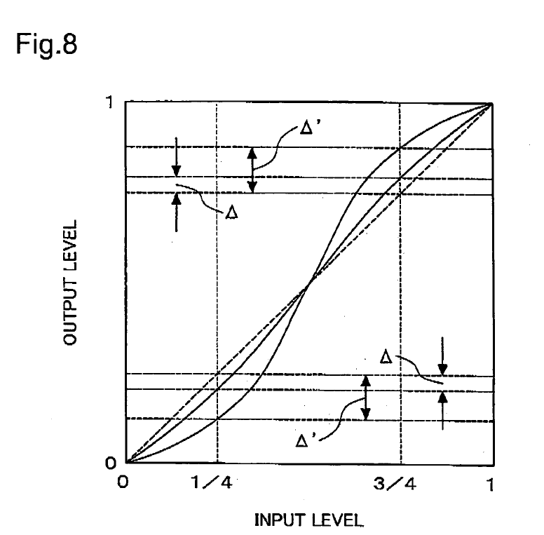

FIG. 8 is an explanatory drawing showing the contents of contrast adjustment in the first embodiment. The input level shows the tone value for the image data before contrast adjustment, while the output level shows the tone value for the image data after contrast adjustment. The graph of FIG. 8 shows an example of a characteristic line (termed a ‘tone curve’) that associates the input level and output level for each RGB component used for contrast adjustment. Contrast adjustment is carried out by the conversion of the RGB components for each pixel using the tone curve. The tone curve is normalized so that the minimum value of the input level and the output level is set to ‘0’ and the maximum value for these levels is set to ‘1’.

This tone curve for contrast adjustment is an S-shaped curve in which the input and output levels are equal at the three points where the input level is 0, 1 and ½, while the output level is lower than the input level when the input level is ¼, and is higher than the input level when the input level is ¾. In this type of tone curve, the slope of the curve in the area where the input level equals ½ is steeper than the characteristic line when adjustment is not performed (the dashed line in FIG. 8). As a result, if image data adjustment is performed using this tone curve, the image contrast increases at input level values near ½. Furthermore, across the entire image, because the output level increases in some areas while the output level decreases in other areas, the brightness of the overall image is approximately the same before and after contrast adjustment.

The degree of contrast adjustment is determined by the amount of shift in the output level at the points where the input level equals ¼ and ¾. Increasing the shift amount from Δ to Δ′ causes the curvature of the tone curve to increase. Furthermore, because the slope of the tone curve at input level values near ½ increases, the contrast of the output image becomes higher. The degree of contrast adjustment can be varied by increasing and decreasing the output level shift amount Δ (also termed the ‘contrast adjustment amount’ below) in this fashion. The method for determining the contrast adjustment amount is described below.

A tone curve having a configuration different from the S-shaped tone curve described above may be used, so long as the slope of the tone curve used for contrast adjustment is steeper for input level values for which the contrast is sought to be increased.

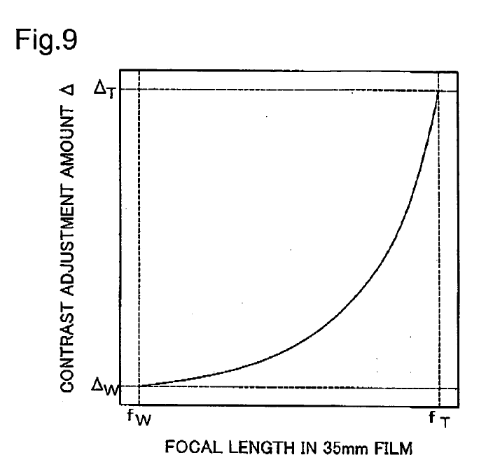

FIG. 9 is an explanatory drawing showing the determination of the contrast adjustment amount in the first embodiment. In general, aberration in the optical system is affected more by the field angle than by the focal length. As described with reference to FIG. 3, the focal length in 35 mm film is a value that effectively indicates the field angle. As a result, in the first embodiment, the contrast adjustment amount A is determined using the focal length in 35 mm film as a parameter indicating the field angle. As described above, the focal length in 35 mm film is recorded in the picture-taking condition information PI contained in the image data file GF (see FIG. 6).

The values f_{W} and f_{T} in FIG. 9 represent focal length in 35 mm films where the focal length of the optical system 210 (see FIG. 2) is at the shortest (wide-angle) and the longest (telephoto) settings, respectively. Furthermore, Δ_{W} represents the contrast adjustment amount where the focal length in 35 mm film is at the minimum value f_{W} and Δ_{T} represents the contrast adjustment amount where the focal length in 35 mm film is at the maximum value f_{T}.

In the first embodiment, the contrast adjustment amount Δ_{W} for a short focal length is smaller than the contrast adjustment amount Δ_{T} for a long focal length, and the contrast adjustment amount is set to increase monotonically as the focal length increases, as shown in FIG. 9. The reason for this is that the amount by which the contrast decreases in areas of small image height increases as the focal length increases.

The contrast adjustment amounts Δ_{W} and Δ_{T} and the contrast adjustment amounts at the focal lengths between the focal length in 35 mm films f_{W} and f_{T} are set appropriately based on the measurement value for the MTF characteristic of the optical system 210 or on the result of estimation of the MTF characteristic by simulation. It is preferred that these contrast adjustment amounts be determined based on the contrast ratio at the center of the picture plane, which often contains the principal photographic subject, and where a decrease in contrast has a significant effect on the image.

The relationship between the focal length in 35 mm film and the contrast adjustment amount can be calculated using the contrast adjustment amount calculation model incorporated in the image processing apparatus and the calculation parameters stored in the hard disk drive 130. The contrast adjustment amount can also be determined with reference to the focal length in 35 mm film and contrast adjustment amount table stored in the hard disk drive.

In the first embodiment, the focal length in 35 mm film contained in the picture-taking condition information PI is used to determine the contrast adjustment amount, but any parameter equivalent to the field angle during picture-taking may be used as the parameter used to determine the contrast adjustment amount. For example, the contrast adjustment amount may be determined based on the field angle calculated from the actual focal length included in the picture-taking condition information PI and from the focal plane resolution.

B. Second Embodiment:

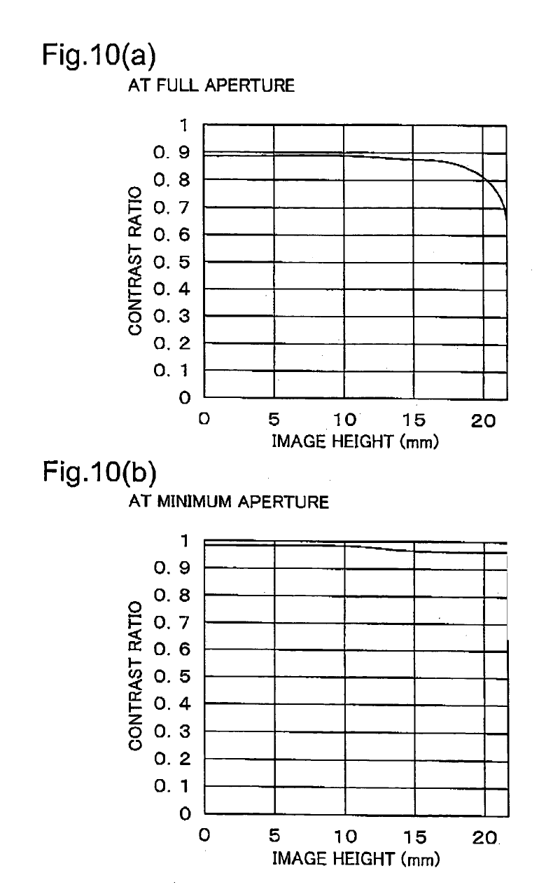

FIGS. 10(a) and 10(b) show the MTF characteristics for the different aperture openings of the optical system 210 (see FIG. 2). As in FIGS. 7(a) and 7(b), the image height indicates the distance from the center of the optical system 210 at the focal plane, and the contrast ratio indicates the ratio between the contrast of a striped pattern and the contrast of the image formed by the optical system 210. FIG. 10(a) shows an example of the MTF characteristic where the aperture of the optical system 210 is at the full aperture state, and FIG. 10(b) shows an example of the MTF characteristic where the aperture of the optical system 210 is at the minimum aperture state. The graphs in FIGS. 10(a) and 10(b) show the MTF characteristics where the focal length of the optical system 210 is longest.

In general, aberration in the optical system decreases as the aperture opening becomes smaller. Consequently, the decrease in contrast at the full aperture state is larger than the decrease in contrast at the minimum aperture state, as shown in FIGS. 10(a) and 10(b). In order to accurately reproduce the contrast of the photographic subject by the contrast adjustment, it is preferred that the contrast adjustment amount be determined in accordance with the aperture state of the optical system 210.

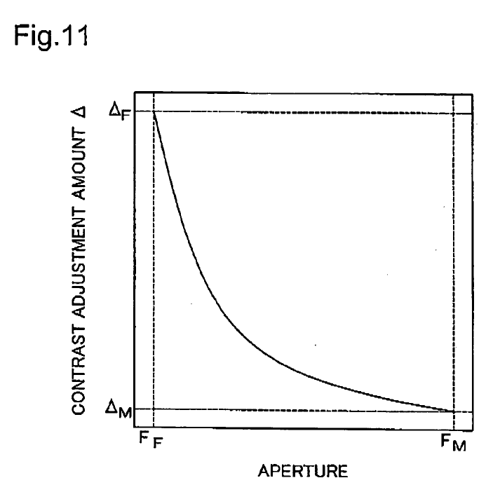

FIG. 11 is an explanatory drawing showing the determination of the contrast adjustment amount in a second embodiment. F_{F} and F_{M} indicate the aperture value where the aperture of the optical system 210 (see FIG. 2) is in the full aperture state and the minimum aperture state respectively. Δ_{F} represents the contrast adjustment amount where the aperture value is at the smallest value F_{F} (full aperture), and Δ_{M} represents the contrast adjustment value where the aperture value is at the maximum value F_{M} (minimum aperture). In addition, in this Specification, the ‘aperture value’ is a parameter value that increases as the diameter of the aperture opening of the optical system 210 decreases.

As described above, because aberration in the optical system decreases as the aperture opening becomes smaller, the contrast adjustment amount is determined such that it decreases as the aperture value increases, as shown in FIG. 11. By determining the contrast adjustment amount in this fashion, the contrast of the photographic subject can be more accurately reproduced. As the aperture value used for the determination of the contrast adjustment amount, the aperture value recorded in the picture-taking condition information PI in the image data file GF (see FIG. 6) may be used, so that the F-number in the picture-taking condition information PI may be used.

The contrast adjustment amounts Δ_{M} and Δ_{F} and the contrast adjustment amounts at aperture values between the aperture values F_{M} and F_{F} are set appropriately based on the measurement value for the MTF characteristic of the optical system 210 or the result of estimation of the MTF characteristic by simulation. As in the first embodiment, it is preferred that the contrast adjustment amount be determined based on the contrast ratio at the center of the picture plane.

Since the arrangement and effect of the second embodiment are otherwise substantially identical to those of the first embodiment, description thereof will be omitted.

In the second embodiment, the contrast adjustment amount is determined based solely on the aperture value of the optical system 210, but it may alternatively be determined based on both the focal length in 35 mm film and the aperture value. In this case, a more appropriate contrast adjustment amount may be determined, and the post-image processing contrast can be made to more closely approximate the contrast of the photographic subject.

C. Modification:

The present invention is not limited to the embodiments and examples described above, and may be realized in various forms within the essential scope of the invention. For example, the following modification is possible.

In the description of the above embodiments, a digital still camera was used as the image input device, but any image input device that performs photoelectric conversion of an image formed using an optical system, such as a digital video camera or image scanner, may be used as the image input device in the present invention.

The present application claims the priority based on Japanese Patent Application No. 2003-196888 filed on Jul. 15, 2003, which is herein incorporated by reference.

1. An image processing method that carries out image processing of image data in accordance with contents of an image data file that includes said image data generated by a digital camera and information regarding picture-taking conditions in effect at the time of said image data generation, said method comprising the steps of:
(a) providing optical system setting information indicating setting parameters of an optical system of said digital camera at the time of generation of said image data included in said picture-taking condition information, and
(b) performing image quality adjustment to adjust said image data based on said optical system setting information.

2. An image processing method according to claim 1, wherein said step (a) comprises the step of providing a focal length in 35 mm film which represents a focal length value of said optical system converted into an equivalent focal length value for a 35 mm camera included in said optical system setting information, said step (b) comprises the step of performing image quality adjustment based on said focal length in 35 mm film.

3. An image processing method according to claim 1, wherein said step (a) comprises the step of providing an aperture value for said optical system included in said optical system setting information, said step (b) comprises the step of performing image quality adjustment based on said aperture value.

4. An image processing method according to claims 1, wherein said step (b) comprises the step of performing contrast adjustment of said image data based on said optical system setting information for image quality adjustment.

5. An image processing method according to claim 4, wherein said step (a) comprises the step of providing a focal length in 35 mm film which represents a focal length value of said optical system converted into an equivalent focal length value for a 35 mm camera included in said optical system setting information, said step (b) comprises the step of increasing an amount of said contrast adjustment as said focal length in 35 mm film increases.

6. An image processing method according to claim 4, wherein said step (a) comprises the step of providing an aperture value for said optical system included in said optical system setting information, said step (b) comprises the step of reducing an amount of said contrast adjustment as said aperture value increases.

7. An image processing apparatus that performs image processing of image data in accordance with contents of an image data file that includes said image data generated by a digital camera and information regarding picture-taking conditions in effect at the time of said image data generation, said apparatus comprising:
an image quality adjuster configured to adjust image quality of said image data based on an optical system setting information included in said picture-taking condition information, said optical system setting information indicating setting parameters for an optical system of said digital camera at the time of said image data generation.

8. A computer program product for processing image data in accordance with contents of an image data file that includes said image data generated by a digital camera and information regarding picture-taking conditions in effect at the time of said image data generation, said computer program product comprising:
a computer readable medium; and
a computer program stored on the computer readable medium, the computer program comprising:
a first program for causing a computer to obtain optical system setting information indicating setting parameters of an optical system of said digital camera at the time of generation of said image data included in said picture-taking condition information; and
a second program for causing the computer to perform image quality adjustment to adjust said image data based on said optical system setting information.
